(19) United States
(12) Patent Application Publication
(10) Pub. No.: US 2020/0024145 A1
(43) Pub. Date: Jan. 23, 2020

(54) METHOD FOR RESOURCE RECOVERY FROM SILICON SLAG AND DEOXIDIZING AGENT FOR IRON AND STEELMAKING

(71) Applicant: Xianghua Kong, Rolling Meadows, IL (US)

(72) Inventor: Xianghua Kong, Rolling Meadows, IL (US)

(73) Assignee: Xianghua Kong, Rolling Meadows, IL (US)

(21) Appl. No.: 16/013,442

(22) Filed: Jul. 18, 2018

(51) Int. Cl. C01B 33/021; B09B 3/00; C21C 7/076

(52) U.S. Cl. CPC C01B 33/021; C21C 7/076; B09B 3/0016; B09B 3/0083

(57) ABSTRACT

Silicon slags, which is a by-product of metallic silicon mill during producing metallurgical grade silicon, solar cell grade silicon and Ferro-silicon alloy. are processed according to the invention to small lumps and briquettes, being excellent deoxidizer for cast iron and steel in order to avoid either costly regeneration for the recovering of the valuable components or the total dumping of said silicon slags. The cost of iron and steelmaking can be reduced significantly. As an additional advantage, the particles of silicon slag in molten steel can absorb the tiny oxides from the deoxidizing reaction and purify the molten steel more quickly.

### TECHNICAL FIELD

The present invention relates to a method of resource recovery of silicon slags from metallic silicon mill and deoxidizer for iron and steelmaking.

### BACKGROUND OF THE INVENTION

Metallic silicon is an important element and has been used in fields of metallurgy, solar cell, semiconductor, and so on. It is well known that slag treatment is an effective way to get high quality metallic silicon, so many documents about slag treatment have been reported. For example, U.S. Pat. No. 4,534,791 discloses a process for treating silicon and Ferrosilicon with slags having the composition: K₂O, Na₂O, CaO, MgO and Al₂O₃. U.S. Pat. No. 7,682,585 discloses a slag treatment process for solar cell grade silicon, in which Nitrogen and aluminum and fluxing agents (Al₂O₃, SiO₂, CaO and MgO) are added to molten silicon to create an oxy-nitride slag that acts as a sink for dissolved boron and phosphorus.

As a result of slag treatment process, a large amount of silicon slag is generated, in which the main compositions include metallic silicon, Na₂O, CaO, SiO₂, MgO and Al₂O₃. In recent years, resources have been increasingly recycled, and several methods have been developed for reuse of silicon-containing residues with high purity. For example: U.S. Pat. No. 4,348,230 discloses a compacted briquettes of metallurgical grade powdered silicon or ferrosilicon and a method for its preparation. The binder is 2 to about 5% by weight of the silicon material of sodium or calcium lignosulfonate. U.S. Pat. No. 5,993,508 discloses that silicon-containing residue from the production of organosilanes can be compacted to briquettes and use as additives for iron-metallurgical smelting process. Besides the silicon-containing residue the briquettes contain 1-10 percent by weight of cardboard fiber, 5-40 percent by weight of hydraulic cement and 0-20 percent by weight of additional additives having influence on the quality of the cast iron. U.S. Pat. No. 9,228,246 discloses the methods for agglomerating recycled fines of silicon/silicon carbide resulting from the cutting of silicon ingots. A variety of organic binders may be used, such as polyvinyl alcohol, molasses, sodium silicate and polyethylene glycol, and the preferred binder is a lignosulsulfonate. The silicon/silicon carbide agglomerations can be used in metallurgical processes as deoxidizing agent. Compared with metallic silicon and Ferrosilicon fine powders, the compositions of silicon slag are more complicated and how to reuse these silicon slags is still a challenge.

Slag treatment is also an important process for steelmaking. Fluxes are the materials used in metallurgical processing to react with impurities to form a liquid slag at the process temperature. In order to accelerate the reaction between slag and molten steel, inert gas is injected through the steel to create a stirring action and therefore, thorough blending. This also helps to reduce the inclusion content (level of non-metallic impurities produced by the deoxidation reactions) of the steel as impurities are swept up and contained by the slag. During steelmaking process, the majority of alloys are added after the end of oxidation, first for de-oxidation (reaction with dissolved oxygen to form fine oxide particles which slowly float out of the liquid steel), then for composition adjustment. Note that this processing can be in two or more vessels—the furnace for maximum reaction or heating, then the ladle for close control in the final stages. Iron/steel slag is composed mainly of CaO and SiO₂, In addition, blast furnace slag contains Al₂O₃, MgO, and S, and steelmaking slag contains iron oxides (FeO, Fe₂O₃), MnO, P₂O₅, etc. As above mentioned, the typical silicon slag contains metallic silicon, Na₂O, CaO, SiO₂, MgO and Al₂O₃, which means most compositions are same as iron/steel slag. As we know, metallic silicon is an important deoxidizer for iron and steel, so silicon slag can be treated as a composite of steel slag and deoxidizing agent, which means silicon slags may be a good substitute for Ferrosilicon alloy as deoxidizer.

Ferrosilicon alloy has been used in iron and steelmaking process for many years. Ferrosilicon is used as a source of metallic silicon to reduce metals from their oxides and to deoxidize steel. Ferrosilicon alloy is also used as alloying element for manufacture of silicon, corrosion-resistant and high-temperature-resistant ferrous silicon alloys, and silicon steel for electromotors and transformer cores. Based on the characteristics of silicon slag, it is a good substitute for FeSi alloy as deoxidizing agent in steelmaking. The silicon slag briquette can be quickly melted in the molten steel, Si loss caused by mingling in steel slag is remarkably reduced and the Si yield is drastically improved. As a potential advantage, the particles of silicon slag in molten steel can absorb the tiny oxides produced by the deoxidation reactions and purify the molten steel more quickly.

Now iron/steel slag generated in the course of iron/steel manufacture is effectively used in multiple ways, such as a raw material for cement, a road base course material, a civil engineering work, and a raw material for fertilizer. So if silicon slags can be used in iron and steelmaking process, metallic silicon can act as deoxidizing agent, and the other compositions can enter into iron/steel slag and reuse with iron/steel slag finally. This is the purpose of this invention.

### REFERENCE OF DRAWINGS

FIG. 1 The schematic of silicon slag processing flow

FIG. 2 The picture of small silicon slag lumps

FIG. 3 The picture of silicon slag briquettes

### SUMMARY OF THE INVENTION

Compared with the actions of iron/steel slag and Ferrosilicon in molten steel, silicon slag can be treated as a composite of steel slag and deoxidizing agent, so a method for resource recovery of silicon slag and deoxidizing agent for iron and steelmaking is developed. To commercialize silicon slag economically, it is necessary to process it to small lumps with size of 10˜100 mm or specified by the customer first, since these small lumps can be used as deoxidizing agent directly. Therefore, the slag is adjusted to specified lump size through a process of crushing and classification. The normal size is 10˜100 mm or as the customer demand. It is a good substitute for FeSi alloy in steelmaking, which can reduce the steelmaking cost significantly. Then the screening residues are pulverized further to fine particles with size smaller than 200 μm, mixed with water soluble silicate solution and compacted to briquettes on briquetting machine. During mixing the metallic silicon particles can react with silicate solution. It is very interesting that this reaction is an exothermic reaction, and the temperature of briquette can reach more than 70 centigrade degree, so the briquette no need further dry in furnace. The briquette is also a good substitute for FeSi alloy in steelmaking.

### DETAILED DESCRIPTION OF THE INVENTION

In order to reuse silicon slags economically, it can be processed to the lump size of 10˜100 mm or as specified by the customer first and used as deoxidizing agent directly. Then the screened residues are pulverized further to fine particles with size smaller than 200 μm, mixed with water soluble silicate solution and compacted to briquettes on briquetting machine. Of course all silicon slags can be crushed into fine particles and compacted to briquettes.

The compacted briquettes of silicon slag is prepared by first mixing together the silicon slags in fine powdered form with 3 to about 10% by weight of silicate solution. Then the obtained plastic homogeneous paste is fed to a briquetting machine, briquettes of the silicon slags are formed and subsequently dried in air. The preferred silicates are sodium silicate and potassium silicate and its weight concentration in water is from 10˜40%. The size of fine powders should be smaller than 200 μm, and the preferred size is 1˜50 μm. It is very interesting that the metallic silicon particles can react with silicate solution during mixing and the reaction is an exothermic reaction, the temperature of briquette can reach more than 70 centigrade degree, so the briquette no need further dry in furnace.

### EXAMPLE

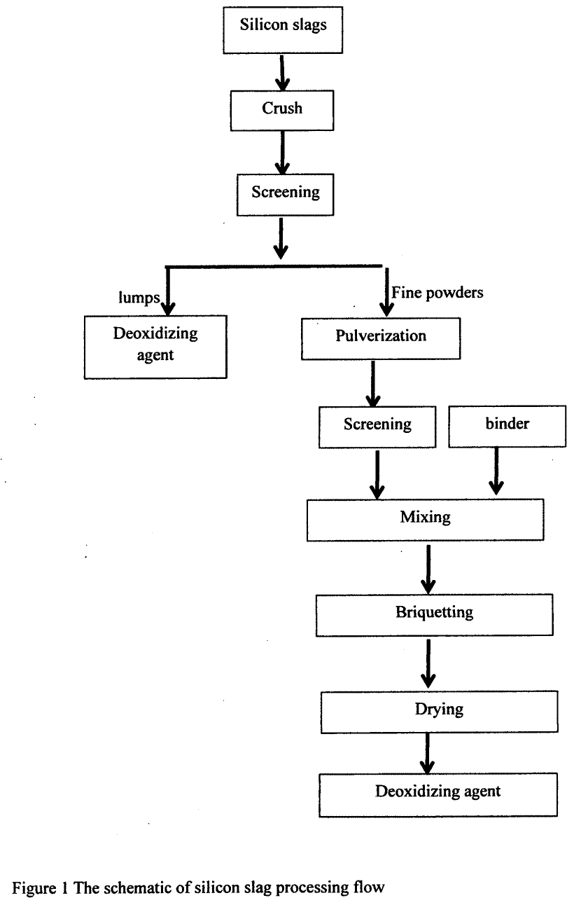

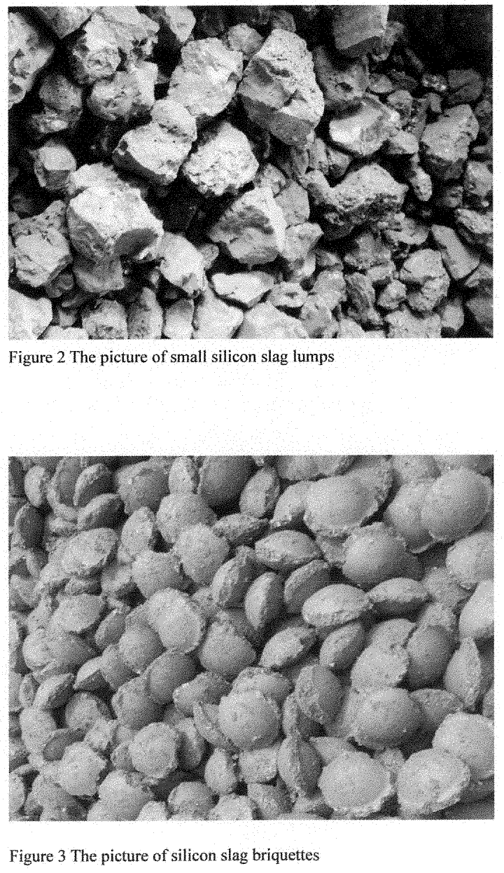

The typical compositions of silicon slags from metallurgical silicon mill is shown in Table 1. The schematic of silicon slag processing flow is shown in FIG. 1. As illustrated in FIG. 1, the silicon slags are crushed by jaw crusher to small lumps with size of 10˜100 mm or as the the customer demand. After screening, the lumps are packaged and used as deoxidizing agent, the picture of these lupms is shown in FIG. 2. The residues are pulverized into fine particles by opposite roller mill, screened again so that the particle diameter is no more than 50 μm. The fine particles are mixed with 5% by weight of sodium silicate solution (30% by weight) for 30 minutes and added into briquetting machine to get silicon slag briquettes with size of 10˜50 mm. The green briquettes are dried in air due to the exothermic reaction between metallic silicon and sodium silicate. The picture of Si slag briquettes is shown in FIG. 3.

TABLE 1
The typical compositions of silicon slags from metallurgical silicon mill

| Si (%) | Fe (%) | Al (%) | Ca (%) | C (%) | S (%) | P (%) | others (%) |
|---|---|---|---|---|---|---|---|
| 65 | 2 | 5 | 5 | 4 | 0.05 | 0.05 | balance |

What is claimed is:

1) Deoxidizing agent for iron and steel-making makes of silicon slag: the silicon slags are processed to small lumps and briquettes, becoming excellent deoxiders for cast iron and steel

2) According to claim (1), the silicon slag is a by-product of metallic silicon mill during producing metallurgical grade silicon, solar cell grade silicon and Ferrosilicon alloys

3) According to claim (1), the silicon slag is crusted to small lumps with size of 10˜100 mm or as the customer demand and used as deoxidizing agent directly

4) According to claim (1), the briquette is made from the mixture of silicon slag and 3˜40% by weight of binder. The silicon slags are are pulverized into fine particles, screened, mixed with binder, compacted into briquettes and dry in air.

5) According to claim (4), the silicon slags are pulverized into fine particles, screened so that the particle diameter is no more than 200 μm, and the preferred diameter is no more than 50 μm.

6) According to claim (4), the binder is water soluble silicate, and the preferred silicates are sodium silicate and potassium silicate. The weight content of silicate solution is 10˜40%.
